(19) United States
(12) Patent Application Publication
(10) Pub. No.: US 2009/0244574 A1
(43) Pub. Date: Oct. 1, 2009

(54) IMAGE FORMING APPARATUS

(75) Inventor: Tomokazu Sakabe, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/411,419

(22) Filed: Mar. 26, 2009

Related U.S. Application Data
(60) Provisional application No. 61/040,903, filed on Mar. 31, 2008.
(60) Provisional application No. 61/040,904, filed on Mar. 31, 2008.

(51) Int. Cl. H04N 1/60

(52) U.S. Cl. 358/1.9

(57) ABSTRACT

An image forming apparatus includes an image forming apparatus body, and an external controller connected to the image forming apparatus body. The image forming apparatus body includes an image processing unit which generates reference density pattern data for detecting image density and an image forming unit which transfers the reference density pattern data generated in the image processing to an intermediate transfer belt as a toner image and detects density on a surface of the intermediate transfer belt, thus acquiring the density data for image correction. The external controller includes an image processing unit 111b which generates a reference density pattern for the external controller for acquiring density data for image correction. In the execution of the density correction, the image processing unit 102b of the image forming apparatus body and the image processing unit of the external controller select and use the reference density pattern data generated for the execution of their respective density corrections.

### CROSS-REFERENCE TO RELATED APPLICATIONS

This application is based upon and claims the benefit of priority from the prior U.S. patent Applications 61/040,903 filed on Mar. 31, 2008 and 61/040,904 filed on Mar. 31, 2008, the entire contents of which are incorporated herein by reference.

### TECHNICAL FIELD

The present invention relates to an electrographic image forming apparatus such as a copy machine or printer, and particularly to density correction in an image forming apparatus equipped with an external controller.

### BACKGROUND

Conventionally, as an image forming apparatus such as a color copy machine, an image forming apparatus in which the image forming apparatus body is equipped with an image forming device capable of forming color images of higher definition as external controller is known.

Meanwhile, in an image forming apparatus such as a color copy machine, image density varies depending on environmental conditions such as the ambient temperature at which the image forming apparatus is used, and on conditions of use such as the number of print sheets. This causes a phenomenon that intended correct color tone cannot be acquired. Therefore, an image quality maintaining control technique is known in which density is corrected in the image forming apparatus every time a status change occurs such as when power is turned on, when a photoconductive drum or a developing device is replaced, or when printing is carried out on a predetermined number of sheets (JP-A-2002-116588).

However, when the image quality maintaining control as described above is carried out in the image forming apparatus equipped with an external controller, the following problem occurs. That is, in the image quality maintaining control, a toner pattern based on reference density pattern data is outputted to an intermediate transfer belt in an image forming unit within the image forming apparatus body, and the intensity of reflected light from the toner pattern is read by a measuring sensor, thereby acquiring density data for correction. Using the acquired density data, an image processing unit corrects density by gamma correction or the like.

Meanwhile, when an image is formed in the external controller, high-quality image data generated on the external controller side is supplied to the image forming unit in the image forming apparatus body. If density correction is carried out on such an image on the image forming apparatus body side, optimum density correction is not carried out in some cases. This is because when image data is generated on the external controller side, high-accuracy image processing unique to the external controller, for example, screening may be carried out. Here, screening refers to processing to generate color gradation using the number or density of color points (or color lines), instead of mixing colors as in the case of paints. This is because optimum correction cannot be carried out by the density correction on such high-accuracy image data within the image forming apparatus body.

It is an object of the invention to provide an image forming apparatus in which the conventional problem is improved.

### SUMMARY

According to an embodiment of the invention, an image forming apparatus includes an image forming apparatus body, and an external controller connected to be capable of communicating image data and various control information with the image forming apparatus body. The image forming apparatus body includes: a transfer unit which transfers a reference density pattern image to an intermediate transfer member; a detector which detects pattern image density on a surface of the intermediate transfer member; an image processing unit which acquires density data for correction corresponding to a value of the image density and carries out density correction of an image by using the density data for correction; and an image data storage unit. The external controller has an image processing unit which carries out density correction of the image by using the density data for correction. The image forming apparatus includes a switching unit which switches reference density pattern data used at the time of carrying out density correction on the image forming apparatus body side and reference density pattern data used at the time of carrying out density correction on the external controller side.

According to another embodiment of the invention, in the image forming apparatus, the reference density pattern data used at the time of carrying out density correction on the external controller side is stored in advance in the image data storage unit in the image forming apparatus body, and density data for correction is acquired in the image forming apparatus body by using the reference density pattern data.

According to still another embodiment, in the image forming apparatus, as a pattern image used at the time of acquiring density data for carrying out density correction on the external controller side, image data is received from the external controller when acquiring the density data for carrying out density correction on the controller side, and the density data is acquired by using the image data.

### DESCRIPTION OF THE DRAWINGS

FIG. 1 is a block diagram showing the configuration of an image forming apparatus according to an embodiment of the invention.

FIG. 2 is a view of schematic configuration showing the specific structure of an image forming unit 104 shown in FIG. 1.

FIG. 3 is a block diagram showing the configuration of an external controller 11 shown in FIG. 1.

FIG. 4A to FIG. 4D show examples of the reference density pattern for density correction.

FIG. 5 is a flowchart for explaining image quality maintaining control in the image forming apparatus according to the embodiment.

FIG. 6 is a flowchart for explaining another example of image quality maintaining control in the image forming apparatus according to the invention.

FIG. 7 is a flowchart for explaining still another example of image quality maintaining control in the image forming apparatus according to the invention.

### DETAILED DESCRIPTION

Hereinafter, an embodiment of the invention will be described in detail with reference to the drawings.

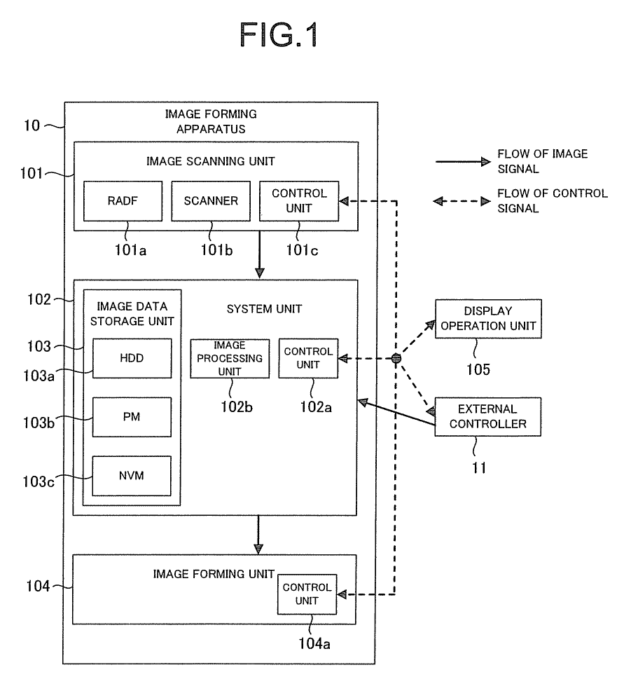

FIG. 1 is a block diagram showing the configuration of an image forming apparatus according to the embodiment of the invention.

An image forming apparatus body 10 shown in FIG. 1 is equipped with an external controller 11. The image forming apparatus body 10 includes an image scanning unit 101, a system unit 102, and an image forming unit 104.

The image scanning unit 101 includes an auto document feeder 101a, a scanner 101b which scans an original carried by the auto document feeder 101a, and a control unit 101c which controls these units.

The system unit 102 includes a control unit 102a, an image processing unit 102b, and an image data storage unit 103. The image data storage unit 103 includes an HDD (hard disk drive) 103a, a PM (page memory) 103b, and an NVM (non-volatile memory).

The image forming unit 104 includes a control unit 104a.

The image forming apparatus body 10 is provided with a display operation unit 105.

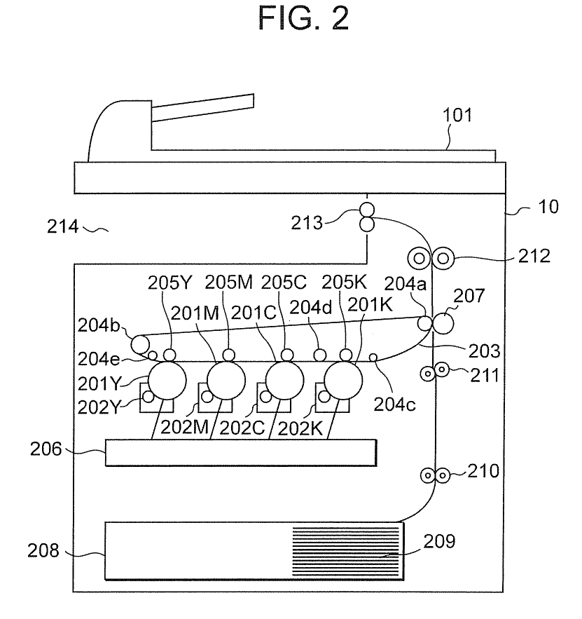

FIG. 2 is a view of schematic configuration showing the specific structure of the image forming unit 104.

Four image formation stations for yellow (Y), magenta (M), cyan (C) and black (K) are arrayed including photoconductive drums 201Y, 201M, 201C and 201K and developing devices 202Y, 202M, 202C and 202K provided for the photoconductive drums. An intermediate transfer belt 203 is provided over and in contact with the photoconductive drums 201Y, 201M, 201C and 201K. Toner images formed on the photoconductive drums 201Y, 201M, 201C and 201K are primary-transferred to the intermediate transfer belt 203. The intermediate transfer belt 203 is tensioned by a backup roller 204a, a driven roller 204b, and first to third tension rollers 204c, 204d and 204e. Also, on the intermediate transfer belt 203, primary transfer rollers 205Y, 205M, 205C and 205K are arranged to nip the intermediate transfer belt 203 with their corresponding photoconductive drums 201Y, 201M, 201C and 201K. The photoconductive drums 201Y, 201M, 201C and 201K are irradiated with exposure light from a laser exposure device 206 and electrostatic latent images are formed thereon. A secondary transfer roller 207 is arranged at a second transfer part, which is the transfer position on the intermediate transfer belt 203 supported by the backup roller 204a. At the secondary transfer part, a predetermined secondary transfer bias is applied to the backup roller 204a. When a recording sheet, which is a recording medium, is passed between the intermediate transfer belt 203 and the secondary transfer roller 207, a toner image on the intermediate transfer belt 203 is secondary-transferred to the recording sheet.

In a lower part within the image forming apparatus body 10, a paper supply cassette 208 is provided. Recording sheets 209 are housed in the paper supply cassette 208. Each of the recording sheets 209, taken out of the paper supply cassette 208 one by one, is guided by a carrying roller pair 210 and a registration roller pair 211 and reaches the secondary transfer roller 207.

The recording sheet 209 which is passed through the secondary transfer roller 207 has the toner image fixed thereto by a fixing roller 212. The recording sheet 209 is discharged to a paper discharge unit 214 via a discharge roller pair 213. The image scanning unit 101 is provided in an upper part of the image forming apparatus body 10.

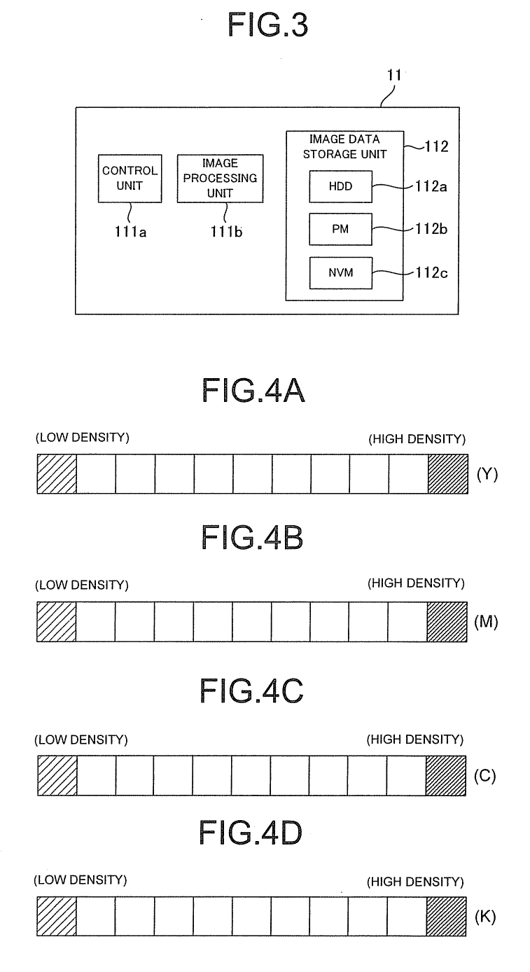

FIG. 3 is a block diagram showing the configuration of the external controller 11 shown in FIG. 1.

The external controller 11 has the same configuration as the system unit 102 in the image forming apparatus body 10 shown in FIG. 1. That is, the external controller 11 includes a control unit 111a, an image processing unit 111b, and an image data storage unit 112. The image data storage unit 112 includes an HDD 112a, a PM 112b, and an NVM 112c.

In the image forming apparatus equipped with this external controller 11, image data generated in the external controller 11 is transferred to the image forming apparatus body 10, and image processing is carried out by the image processing unit 102b, if necessary. A toner image is formed by the image forming unit 104 and then printed on the recording sheet 209 shown in FIG. 2. The recording sheet 209 is then discharged to the paper discharge unit 214.

In the image forming apparatus body 10, density varies because of the influence of temperature and humidity with the lapse of time, as described above. Therefore, the density change is corrected every predetermined time period or every predetermined number of sheets. In this image quality maintaining control, reference density pattern data, which is test pattern data for acquiring density correction data, is generated by the image forming unit 104 in the image forming apparatus body 10. This toner pattern is outputted to the surface of the intermediate transfer belt 203 shown in FIG. 2. The reflection density of the toner pattern is read by a measuring sensor (not shown). Thus, density data is acquired.

FIG. 4A to FIG. 4D show examples of the reference density pattern for acquiring the density correction data. FIG. 4A to FIG. 4D show stripe reference density patterns corresponding to yellow (Y), magenta (M), cyan (C) and black (K), respectively. In the reference density patterns shown in FIG. 4A to FIG. 4D, the density of each color changes stepwise from low density to high density. Data representing such reference density patterns are generated by the image processing unit 102b of the system unit 102 in the image forming apparatus body 10 and then sent to the image forming unit 104. Thus, density data is acquired as described above. When carrying out printing in the image forming apparatus body 10, the image processing unit 102b corrects density by gamma correction or the like, using this density data.

Meanwhile, when an image is generated by the external controller 11, there is a mode in which processing like screening unique to the external controller 11 is carried out. In order to carry out highly accurate density correction to such an image, it is necessary to use pattern data to which this unique screening or the like is carried out, in the image quality maintaining control, and thus acquire density data.

Therefore, in this embodiment, by preparing a reference density pattern for the image forming apparatus body and a reference density pattern for the external controller in the image quality maintaining control, then switching these patterns, and acquiring density data with respect to each reference density patter, it is possible to carry out optimum density correction in each printing.

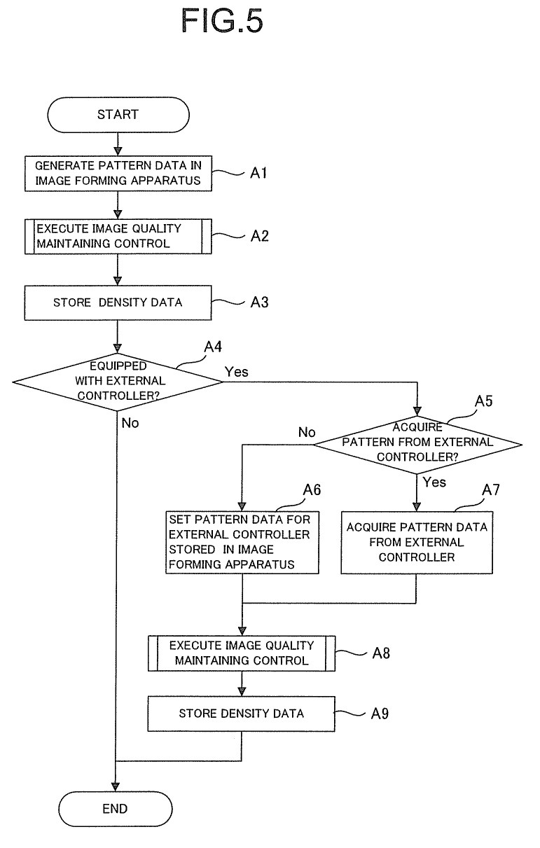

FIG. 5 is a flowchart for explaining the image quality maintaining control in the image forming apparatus according to the embodiment configured as described above. Hereinafter, the image quality maintaining control method will be described with reference to the flowchart.

First, control is initiated at the start (START). In ACT 1, reference density pattern data is generated by the image forming unit 104 in the image forming apparatus body 10 (A1). Using this reference density pattern data, image quality maintaining control is executed in ACT 2 (A2) Density data acquired as a result of this is stored in the non-volatile memory NVM 103a in the system unit 102 of the image forming apparatus body 10 (A3). Then, in ACT 4, it is checked whether the apparatus body is equipped with an external controller or not (A4). If the apparatus body is not equipped with an external controller (No), the image quality maintaining control is ended (END).

If the apparatus body is equipped with an external controller (Yes) in ACT 4, the processing goes to ACT 5. It is checked whether a reference density pattern needs to be acquired from the external controller or not (A5) If a reference density pattern needs not be acquired (No), reference density pattern data for the external controller stored in the HDD 103a in the system unit 102 of the image forming apparatus body 10 is read out and set to the image forming unit 104 in the image forming apparatus body 10 (A6). If it is determined that a reference density pattern needs to be acquired from the external controller (Yes) as a result of the check in ACT 5, reference density pattern data is acquired from the external controller and set to the image forming unit 104 in the image forming apparatus body 10 in ACT 7 (A7).

In the external controller, reference density pattern data for the external controller is generated by the image processing unit 11b in the external controller 11 shown in FIG. 3. This reference density pattern is substantially the same density pattern as the reference density patterns shown in FIG. 4A to FIG. 4D except that this reference density pattern is a higher-definition image pattern including screening or the like unique to the external controller. The reference density pattern data for the external controller thus generated is sent to the system unit 102 of the image forming apparatus body 10 and stored in the HDD 103a in the image data storage unit 103 or stored in the HDD 112a in the image data storage unit 112 of the external controller 11.

In ACT 8, the image forming unit 104 executes the image quality maintaining control (A8) similarly to ACT 2 by using the reference density pattern data for the external controller that is set in ACT 6 or ACT 7. In this case, the reference density pattern data for the external controller stored in the HDD 103a of the system unit 102 of the image forming apparatus body 10 is read out from the HDD 103a and developed to the PM 103b in the image data storage unit 103. This data is transferred to the image forming unit 104 and then outputted as a toner image onto the intermediate transfer belt 203. Thus, density data is acquired. Image correction such as gamma correction using this density data is carried out by the image processing unit 111b (FIG. 3) of the external controller 11.

The acquired density data is stored in the non-volatile memory NVM 103c in the image forming apparatus body 10 in ACT 9 (A9). Then, the image quality maintaining control is ended (END).

When executing the image quality maintaining control in this manner in the image forming apparatus, the reference density pattern data generated in the image forming apparatus body 10 is used for an image formed in the image forming apparatus body 10. However, for an image that is formed in the external controller 11 and has different screen characteristics or the like, the reference density pattern data generated on the external controller side is received from the external controller and the image quality maintaining control is executed by using this. Then, the density data thus acquired is transferred to the external controller, and a corrected image is generated in consideration of density change at the time of generating image data on the external controller side. Thus, optimum image output can be realized.

In this example, the image quality maintaining control for the external controller is carried out at the same timing as the image quality maintaining control for the internal controller.

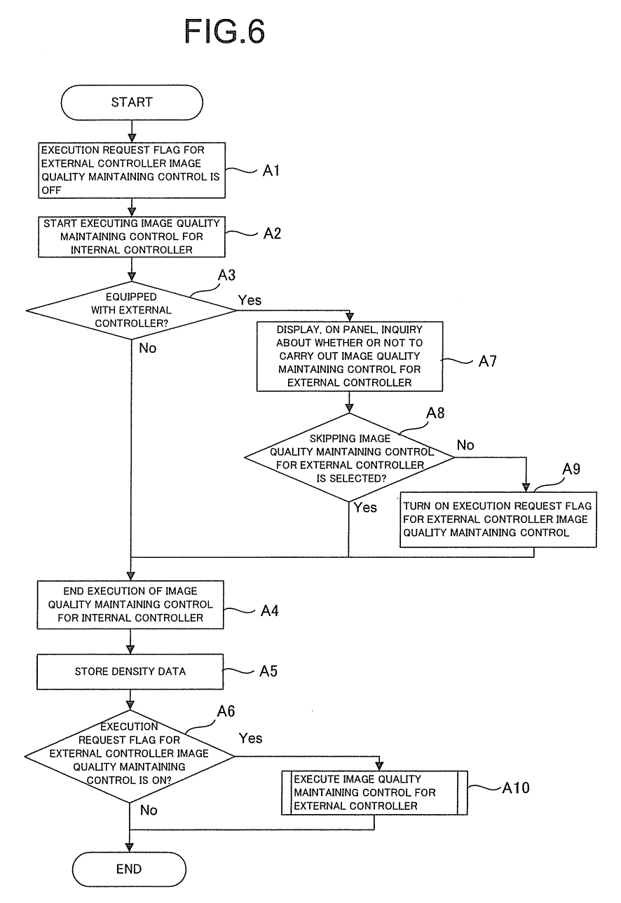

FIG. 6 is a flowchart for explaining another example of the image quality maintaining control in the image forming apparatus according to the invention. In this flowchart, the image forming apparatus body 10 is described as an internal controller in contrast to the external controller for convenience.

First, control is initiated at the start (START). In ACT 1, it is confirmed that an execution request flag for external controller image quality maintaining control is OFF (A1). The processing goes to ACT 2 and execution of the image quality maintaining control by the internal controller 10 is started (A2). Then, in ACT 3, it is checked whether the internal controller 10 is equipped with an external controller or not (A3). If the internal controller 10 is not equipped with an external controller (No), the processing goes to ACT 4 and the image quantity maintaining control for the internal controller is ended (A4). Density information acquired as a result of this is stored in the non-volatile memory NVM 103c of the image data storage unit 103 in the internal controller 10 shown in FIG. 1 (A5). After that, in ACT 6, it is checked whether the execution request flag for external controller image quality maintaining control is ON or not (A6). If the flag is not ON (No), the processing ends (END).

If the internal controller 10 is equipped with an external controller (Yes) in ACT 3, the processing goes to ACT 7. An inquiry about whether to carry out the image quality maintaining control for the external controller or not is displayed on the panel of the display operation unit 105 in the internal controller 10 (A7). The processing then goes to ACT 8, and it is checked whether or not the user selects skipping the execution of the image quality maintaining control for the external controller in response to the inquiry displayed on the panel of the display operation unit 105 (A8). If the user selects skipping as a result (Yes), the processing goes to ACT 4 and the image quality maintaining control for the internal controller is ended (A4). Meanwhile, if the user does not select skipping the execution of the image quality maintaining control for the external controller (No) in ACT 8 in response to the inquiry displayed on the panel of the display operation unit 105, the processing goes to ACT 9 and it is confirmed that the execution request flag for external controller image quality maintaining control is ON. Then, the processing goes to ACT 6 via ACT 4 and ACT 5. In ACT 6, it is checked whether the execution request flag for external controller image quality maintaining control is ON or not. If the flag is ON, the processing goes to ACT 10 (A10).

In ACT 10, the image quality maintaining control for the external controller is executed (A10).

In this image quality maintaining control for the external controller, as described in ACT 6 to ACT 9 in FIG. 5, the reference density pattern data for the external controller, generated in the external controller 11 and stored in the non-volatile memory NVM 103c in the internal controller 10, is read out from the non-volatile memory NVM 103c and developed to the PM 103b in the image data storage unit 103. The data developed to the PM 103b is transferred to the image forming unit 104 and then outputted as a toner image onto the intermediate transfer belt 203. Thus, density data is acquired. The density information thus acquired is sent to the external controller 11 shown in FIG. 3 and temporarily stored in the non-volatile memory NVM 112c in the image data storage unit 112. In the external controller 11, image correction such as gamma correction using this density data is carried out by the image processing unit 111b. After that, the image quality maintaining control for the external controller is ended and all the image quality maintaining controls are ended (END).

In this example, the waiting time required for the image quality maintaining control for the external controller can be reduced since the user can select whether to execute or skip the image quality maintaining control for the external controller, when executing the image quality maintaining control for the internal controller.

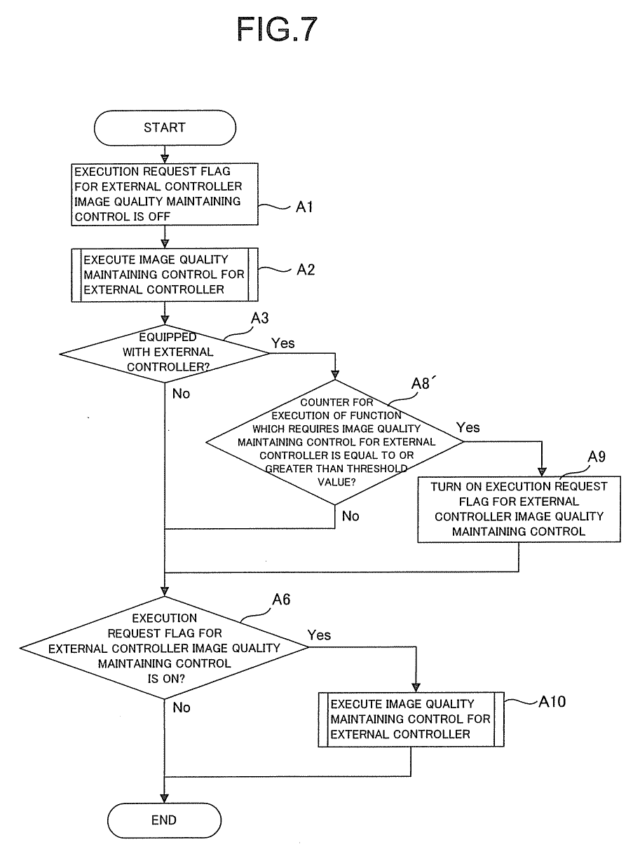

FIG. 7 is a flowchart for explaining still another example of the image quality maintaining control in the image forming apparatus according to the invention. Since the flow of FIG. 7 is the same as the flow of FIG. 6 except for some parts, the same parts are denoted by the same reference numerals and will not be described further in detail.

The flowchart in this example differs from the flowchart of FIG. 6 as follows. That is, in the flowchart of FIG. 6, an inquiry about whether or not to carry out the image quality maintaining control for the external controller is displayed on the panel of the display operation unit 105 in the internal controller 10 in ACT 7 (A7) and then it is checked in ACT 8 (A8) whether or not the user selects skipping the execution of the image quality maintaining control for the external controller in response to the inquiry displayed on the panel of the display operation unit 105. Thus, whether or not to execute the image quality maintaining control for the external controller is decided.

On the contrary, in the flowchart of FIG. 7, in ACT 8′, the state of use of a function which requires the image quality maintaining control for the external controller is counted by a counter and it is checked whether the count value is a predetermined threshold value or greater (A8′). Here, the function which requires the image quality maintaining control for the external controller refers to, for example, the following function. That is, as described above, the external controller is a device which forms an image of higher definition, compared to the internal controller, which is the image forming apparatus body 10. For example, the image density of the internal controller is 600 dpi, whereas the image density of the external controller is 1200 dpi. In such a case, the function which requires the image quality maintaining control for the external controller refers to printing with the image density of 1200 dpi, and the count value means the number of times printing is carried out with the image density of 1200 dpi.

If the count value is equal to or greater than the threshold value (Yes) as a result of the check in ACT 8′, the processing goes to ACT 9 and the execution flag for external controller image quality maintaining control is turned on. If the threshold value is not reached (No) as a result of the check, the processing goes to ACT 6. If the flag is ON, the image quality maintaining control for the external controller is executed in ACT 10.

Thus, the need to execute the image quality maintaining control for the external controller is automatically determined without making any inquiry to the user. Therefore, the image quality maintaining control for the external controller can be carried out at the minimum and appropriate timing.

What is claimed is:

1. An image forming apparatus comprising an image forming apparatus body, and an external controller connected to be capable of communicating with the image forming apparatus body and having a different image processing function from the image forming apparatus body,
the image forming apparatus body comprising:
an image processing unit which generates reference density pattern data for detecting image density and carries out density correction of an image by using density data for image correction acquired by using the reference density pattern;
a system unit including an image data storage unit which stores the reference density pattern data generated by the image processing unit; and
an image forming unit which transfers the reference density pattern data generated in the system unit to an intermediate transfer member as a toner image and detects density on a surface of the intermediate transfer member, thus acquiring the density data for image correction,
the external controller comprising:
an image processing unit which generates a reference density pattern for the external controller for detecting image density and carries out density correction of an image by using density data for image correction acquired by using the reference density patter; and
a system unit including an image data storage unit which stores the reference density pattern data generated by the image processing unit,
wherein in the execution of the density correction, the image processing unit of the image forming apparatus body and the image processing unit of the external controller select and use the reference density pattern data generated for the execution of their respective density corrections.

2. The apparatus according to claim 1, wherein the image forming unit includes plural photoconductive drums corresponding to different color light, and a developing device provided in each of the photoconductive drums.

3. The apparatus according to claim 2, wherein the reference density pattern data is data corresponding to the different color light and representing a pattern of plural densities in which the density sequentially changes in each color light.

4. The apparatus according to claim 3, wherein the reference density pattern data for the external controller is processed by different image processing from the reference density pattern data generated by the image processing unit of the image forming apparatus body.

5. The apparatus according to claim 4, wherein the reference density pattern data used to carry out the density correction on the external controller side is stored in advance in the image data storage unit in the image forming apparatus body.

6. The apparatus according to claim 4, wherein the reference density pattern data used to carry out the density correction on the external controller side is received from the external controller when carrying out the density correction on the image forming apparatus body side, and density data is acquired by using the reference density pattern data.

7. The apparatus according to claim 4, wherein the density correction executed by the image forming apparatus body and the density correction executed on the external controller side are executed at the same timing.

8. The apparatus according to claim 7, wherein execution of the density correction executed by the external controller is skipped in accordance with an instruction from a user when executing the density correction by the image forming apparatus body.

9. The apparatus according to claim 8, wherein the instruction from the user is given in the form of a response operation to an inquiry displayed on a display operation unit provided in the image forming apparatus body.

10. The apparatus according to claim 7, wherein the density correction executed by the external controller is executed if frequency of use of a function which requires the density correction in the external controller exceeds a predetermined threshold value, when executing the density correction by the image forming apparatus body.

11. An image forming apparatus comprising an image forming apparatus body, and an external controller connected to be capable of communicating image data and various information with the image forming apparatus body,
the image forming apparatus body comprising:
a transfer unit which transfers a reference density pattern image to an intermediate transfer member;
a detector which detects reflection density on a surface of the intermediate transfer member;
an image data storage unit which stores density data corresponding to a value of the reflection density; and
an image processing unit which carries out density correction of an image by using the density data stored in the image data storage unit,
the external controller comprising an image processing unit which carries out density correction of an image by using the density data,
wherein the image forming apparatus further comprises a switching unit which switches a reference density pattern image used at the time of carrying out the density correction on the image forming apparatus body side and a pattern image used at the time of carrying out the density correction on the external controller side.

12. The apparatus according to claim 11, wherein the image forming unit includes plural photoconductive drums corresponding to different color light, and a developing device provided in each of the photoconductive drums.

13. The apparatus according to claim 12, wherein the reference density pattern data is data corresponding to the different color light and representing a pattern of plural densities in which the density sequentially changes in each color light.

14. The apparatus according to claim 13, wherein the reference density pattern data for the external controller is processed by different image processing from the reference density pattern data generated by the image processing unit of the image forming apparatus body.

15. The apparatus according to claim 14, wherein the reference density pattern image used at the time of carrying out the density correction on the external controller side is stored in advance in the image data storage unit in the image forming apparatus body, and density data is acquired in the image forming apparatus body by using the reference density pattern image.

16. The apparatus according to claim 14, wherein a pattern image used at the time of acquiring density data for carrying out the density correction on the external controller side is received from the external controller when carrying out the density correction on the image forming apparatus body side, and density data is acquired by using the pattern image.

17. The apparatus according to claim 14, wherein the density correction executed by the image forming apparatus body and the density correction executed on the external controller side are executed at the same timing.

18. The apparatus according to claim 17, wherein the density correction executed by the external controller is executed in accordance with an instruction from a user when executing the density correction by the image forming apparatus body.

19. The apparatus according to claim 18, wherein the instruction from the user is given in the form of a response operation to an inquiry displayed on a display operation unit provided in the image forming apparatus body.

20. The apparatus according to claim 17, wherein the density correction executed by the external controller is executed if frequency of use of a function which requires the density correction in the external controller exceeds a predetermined threshold value, when executing the density correction by the image forming apparatus body.
